(19) United States
(12) Patent Application Publication
(10) Pub. No.: US 2026/0153849 A1
(43) Pub. Date: Jun. 4, 2026

(54) SYSTEM FOR RECORDING OR PLAYING OF SCADA SCENE TO WHICH DIGITAL TWIN OF SCADA SYSTEM IS APPLIED AND METHOD THEREOF

(71) Applicant: CIMON Co., Ltd., Yongin-si (KR)

(72) Inventor: Jae Yong CHANG, Seoul (KR)

(73) Assignee: CIMON Co., Ltd., Yongin-si (KR)

(21) Appl. No.: 19/336,778

(22) Filed: Sep. 23, 2025

(30) Foreign Application Priority Data
Dec. 3, 2024 (KR) 10-2024-0177432

(51) Int. Cl. G05B 19/05; G06T 15/08; G06V 10/25; G06V 20/00

(52) U.S. Cl. CPC G05B 19/054; G06T 15/08; G06V 10/25; G06V 20/36; G05B 2219/2241; G05B 2219/23182; G05B 2219/23377; G05B 2219/24215; G05B 2219/25266

(57) ABSTRACT

A system for recording or playing a SCADA scene and a method thereof, wherein PLC data tags collected in real time from a PLC are applied to a 3D digital twin model to display the PLC data tags as a SCADA scene, and the collected PLC data tags, additional information, etc., are stored in a buffer allocated to a database, and data stored in the buffer according to a preset storage method when a preset recording button according to a user selection is selected, data stored in an additional buffer during a preset period of time from a time of selecting a recording button, etc., are stored in the database, thereby improving operational efficiency of the database by storing related data without being affected by a size, a resolution, etc., of the SCADA scene, and preserving the related data before and after an event occurs.

### CROSS-REFERENCE TO RELATED APPLICATION

This application claims priority to and the benefit of Korean Patent Application No. 10-2024-0177432, filed on Dec. 3, 2024, the disclosure of which is incorporated herein by reference in its entirety.

### BACKGROUND

### 1. Field of the Invention

The present invention relates to a system for recording or playing a supervisory control and data acquisition (SCADA) scene to which a digital twin of a SCADA system is applied and a method thereof, and more particularly, to a system for recording or playing a SCADA scene to which a digital twin of a SCADA system is applied, which applies programmable logic controller (PLC) data tags collected from a PLC in real time to a 3D digital twin model to display the PLC data tags as a SCADA scene, stores the collected PLC data tags, additional information, etc., in a buffer allocated to a database, and stores, in the database, data stored in the buffer according to a preset storage method, data stored in an additional buffer during a preset period of time from a time of selecting a recording button, etc., when a preset recording button is selected according to a user selection, and a method thereof.

### 2. Discussion of Related Art

Supervisory control and data acquisition (SCADA) refers to a supervisory control function of a SCADA system, also known as a centralized remote monitoring control system or a supervisory control data acquisition system. The SCADA system refers to a system that collects·receives·records·displays state information data from remote terminal units using analog or digital signals over communication channels, allowing a central control system to monitor and control the remote devices, and is a system that centrally monitor and control various types of remote facility devices such as power generation, ·power transmission and distribution facilities, petrochemical plants, steelmaking facilities, and factory automation facilities.

In order to record the scene while the digital twin is applied to the SCADA system, a method of recording the scene as an image and storing the scene in the form of an image file is used. As the method of playing a stored image file is used, a huge amount of storage space is required for the image file depending on a storage time, a size, resolution, the number of frames per second of the scene, etc. In addition, as the scene is stored in the form of the image file, the effects of a 3D object model of the SCADA system with the digital twin applied may not be used, and there are limitations in analyzing the causes of important event occurrence and accidents due to the recording of simple scene.

In addition, as the SCADA system uses a method of recording a scene as an image and storing a scene in the form of an image file while the digital twin is applied to the SCADA system and the method of playing the stored image file is used, when image is recorded based on a specific event, the analysis of the event and accident essentially requires the image recording scene from a certain time before the event occurs. However, since the occurrence of the event or accident may not be predicted in advance, continuous recording is always required to preserve the image scene before the occurrence of such an event or accident, and additional costs for storage capacity are incurred accordingly.

### RELATED ART DOCUMENT

### Patent Document

(Patent literature 1) Korean Patent No. 10-1887384 [Title: SCADA system and operation method thereof]

### SUMMARY OF THE INVENTION

The present invention is directed to providing a system for recording or playing a supervisory control and data acquisition (SCADA) scene to which a digital twin of a SCADA system is applied that applies programmable logic controller (PLC) data tags collected from a PLC in real time to a 3D digital twin model to display the PLC data tags as a SCADA scene, and stores the collected PLC data tags, additional information, etc., in a buffer allocated to a database, and stores, in the database, data stored in the buffer according to a preset storage method, data stored in an additional buffer during a preset period of time from a time of selecting a recording button, etc., when a preset recording button according to a user selection is selected, and a method thereof.

In addition, the present invention is directed to providing a system for recording or playing a SCADA scene to which a digital twin of a SCADA system is applied, which, when specific data is selected according to user selection from data including one or more PLC data tags, etc., stored in a database, plays the PLC data tags, additional information, etc., related to the selected specific data on the SCADA scene, and a method thereof.

According to an aspect of the present invention, there is provided a system for recording or playing a SCADA scene to which a digital twin of a SCADA system is applied, including a database configured to allocate a buffer for temporarily storing data, and a server configured to output a three-dimensional (3D) digital twin model connected to one or more programmable logic controller (PLC) data tags collected from a PLC corresponding to a facility on the SCADA scene, store the one or more PLC data tags collected from the PLC using a predetermined method at a preset cycle and additional information collected in relation to the facility in the buffer allocated to the database, when a preset save button displayed on one side of the SCADA scene is selected, confirm a preset storage method, when the confirmed storage method is an integrated data storage method, allocate a portion of the storage space of the database by linking with the database to configure an additional buffer, based on a time of selecting the save button, store the one or more PLC data tags collected from one or more PLCs at the preset cycle and the additional information collected in relation to the facility in the additional buffer from a time of selecting the save button to a time of selecting an end button later or during a preset additional save time, and when the end button is selected or the additional save time has elapsed, based on the time of selecting the save button, store, in a timelist table and a page name universally unique identifier table (UUID) table allocated to the database, page information that includes the one or more PLC data tags and the additional information collected and stored in the buffer at the preset cycle from a time before the selection of the save button to the time of selecting the save button, the one or more PLC data tags and the additional information being stored in the additional buffer, information on a capturing area related to the equipment, one or more objects recognized from image information related to the facility, and information on the 3D digital twin model related to the SCADA scene.

The SCADA scene may perform artificial intelligence-based learning based on image information including one or more facilities located within the preset capturing area to recognize one or more objects included in the image information based on the training result, identify a specific 3D digital twin model related to the recognized object among a plurality of pre-stored 3D digital twin models, search for a specific PLC data tag related to the identified specific 3D digital twin model among a plurality of pre-stored PLC data tags, connect the searched specific PLC data tag to the confirmed specific 3D digital twin model, generate the digital twin by performing 3D rendering based on the image information and the specific 3D digital twin model to which the specific PLC data tag is connected, and configure the generated digital twin as the SCADA scene using a preset 3D engine.

According to another aspect of the present invention, there is provided a method of recording or playing a SCADA scene to which a digital twin of a SCADA system is applied, including outputting, by a server, a three-dimensional (3D) digital twin model connected to one or more programmable logic controller (PLC) data tags collected from a PLC corresponding to a facility to the SCADA scene, and storing the one or more PLC data tags collected from the PLC using a predetermined method at a preset cycle and additional information collected in relation to the facility in a buffer allocated to a database, when a preset save button displayed on one side of the SCADA scene is selected, confirming, by the server, a preset storage method, when the confirmed storage method is an integrated data storage method, allocating, by the server, a portion of the storage space of the database by linking with the database to configure an additional buffer, based on the time of selecting the save button, storing, by the server, in the additional buffer, the one or more PLC data tags collected from one or more PLCs at the preset cycle and the additional information collected in relation to the facility from the time of selecting the save button to a time of selecting an end button later or during a preset additional save time, when the end button is selected or the additional save time has elapsed, based on the time of selecting the save button, storing, by the server, in a timelist table and a page name universally unique identifier table (UUID) table allocated to the database, page information that includes the one or more PLC data tags and the additional information collected and stored in the buffer at the preset cycle from the time before the selection of the save button to the time of selecting the save button, the one or more PLC data tags and the additional information being stored in the additional buffer, information on a capturing area related to the equipment, one or more objects recognized from image information related to the facility, and information on the 3D digital twin model related to the SCADA scene, and after the data stored in the buffer and the additional buffer is completely stored in the timelist table and the page name UUID table, initializing, by the server, the allocated buffer and the additional buffer by linking with the database.

The method may further include, when the confirmed storage method is a previous data storage method, storing, by the server, in the timelist table and the page name UUID table allocated to the database, the page information that includes the one or more PLC data tags and the additional information collected and stored in the buffer at the preset cycle from the time before the selection of the save button to the time of selecting the save button, information on a capturing area related to the equipment, one or more objects recognized from image information related to the facility, and information on the 3D digital twin model related to the SCADA scene, and after the data stored in the buffer is completely stored in the timelist table and the page name UUID table, initializing, by the server, the allocated buffer by linking with the database.

The method may further include when the confirmed storage method is a subsequent data storage method, allocating, by the server, a portion of the storage space of the database by linking with the database to configure an additional buffer, based on the time of selecting the save button, storing, by the server, in another additional buffer, the one or more PLC data tags collected from one or more PLCs at the preset cycle and the additional information collected in relation to the facility from the time of selecting the save button to the time of selecting the end button later or during a preset additional save time, when the end button is selected or when the additional storage time has elapsed, storing, by the server, in the timelist table and the page name UUID table allocated to the database, the page information that includes the one or more PLC data tags and the additional information being stored in the another additional buffer, the information on the capturing area related to the facility, the one or more objects recognized from the image information related to the facility, and the information on the 3D digital twin model related to the SCADA scene, and after the data stored in the additional buffer is completely stored in the timelist table and the page name UUID table, initializing, by the server, the allocated buffer and the another additional buffer by linking with the database.

According to still another aspect of the present invention, there is provided a method of recording or playing a supervisory control and data acquisition (SCADA) scene to which a digital twin of a SCADA system is applied, including, when a preset playback menu displayed on one side of an app execution result scene on a preset SCADA software displayed on a server is selected, displaying, by the server, a file selection scene corresponding to the selected playback menu, when information on any one of the SCADA scenes corresponding to the UUIDs related to one or more pieces of data included in a list displayed on the file selection scene of the server is selected, loading, by the server, the page information that includes the one or more PLC data tags, the additional information, the information on the capturing area related to the facility, the one or more objects recognized from the image information related to the facility, and the information on the 3D digital twin model related to the SCADA scene, which are being stored in the database in chronological order in response to the information on the selected one of the SCADA scenes, by linking with the database, confirming, by the server, a specific 3D digital twin model related to the one or more objects loaded among a plurality of pre-stored 3D digital twin models; connecting, by the server, the loaded one or more PLC data tags to the confirmed specific 3D specific twin model, generating, by the server, the digital twin by performing the 3D rendering based on the specific 3D digital twin model connected to the one or more PLC data tags and the additional information, and outputting, by the server, the generated digital twin to the SCADA scene.

The method may further include, when a check box of at least one option selection information is selected from among the pieces of option selection information related to the additional information displayed in a form of a check box on one side of the SCADA scene, updating, by the server, information related to the at least one option selection information corresponding to the selected check box to the digital twin and outputting the updated digital twin to the SCADA scene.

### BRIEF DESCRIPTION OF DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration of a system for recording or playing a SCADA scene to which a digital twin of a SCADA system is applied according to an embodiment of the present invention;

FIG. 2 is a flowchart illustrating a method of recording or playing a SCADA scene to which a digital twin of a SCADA system is applied according to a first embodiment of the present invention; and

FIG. 3 is a flowchart illustrating a method of recording or playing a SCADA scene to which a digital twin of a SCADA system is applied according to a second embodiment of the present invention.

### DETAILED DESCRIPTION OF EXEMPLARY EMBODIMENTS

It is to be noted that technical terms used in the present invention are used in order to describe only specific exemplary embodiments rather than restricting the present invention. In addition, unless indicated otherwise in the present invention, it is to be understood that all the technical terms used in the present invention are construed as meaning as those that are generally understood by those who skilled in the art and as excessively comprehensive meanings and excessively reduced meanings. In addition, when the technical terms used in the present invention are wrongly technical terms that do not accurately indicate the technical spirit of the present invention, it is to be understood that the terms are replaced with the technical terms understood by those skilled in the art. Further, the general terms used in the present invention must be understood according to the terms defined by the dictionary or the context and should not be excessively reduced meanings.

In addition, singular forms used in the present invention are intended to include plural forms unless the context clearly indicates otherwise. In the present invention, it is to be noted that the terms “configured of,” “including,” or the like, are not be construed as necessarily including several components or several steps described in the present invention and some of the above components or steps may not be included or additional components or steps are construed as being further included.

Terms including an ordinal number such as first, second, or the like, used in the present invention may be used to describe various components. However, these components are not limited to these terms. Terms are used only in order to distinguish one component from another component. For example, a first component may be named a second component, and similarly, the second component may be named the second component, without departing from the scope of the present invention.

Hereinafter, exemplary embodiments of the present invention will be described in detail with reference to the accompanying drawings. The same reference numerals will be used to describe the same or like components, independent of the reference numerals and an overlapped description of the same components will be omitted.

Further, when it is decided that the detailed description of the known art related to the present invention may obscure the gist of the present invention, the detailed description thereof will be omitted. In addition, it is to be noted that the accompanying drawings are provided only in order to allow the spirit of the present invention to be easily understood and is to be interpreted as limiting the spirit of the present invention.

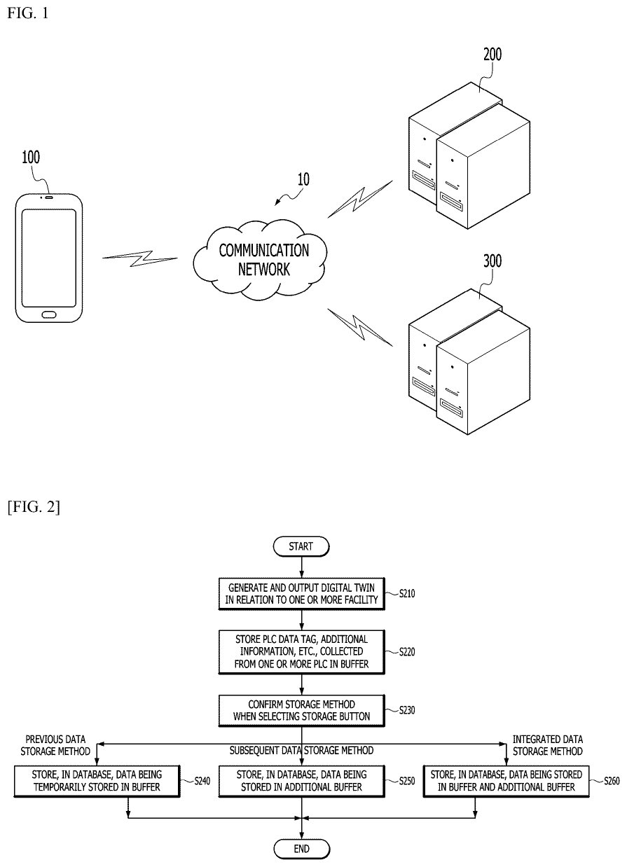

FIG. 1 is a block diagram illustrating a configuration of a system 10 for recording or playing a supervisory control and data acquisition (SCADA) scene to which a digital twin of a SCADA system is applied according to an embodiment of the present invention.

As illustrated in FIG. 1, the system 10 for recording or playing a SCADA scene to which a digital twin of a SCADA system is applied includes a programmable logic controller (PLC) 100, a server 200, and a database 300. Not all components of the system 10 for recording or playing a SCADA scene to which a digital twin of a SCADA system is applied illustrated in FIG. 1 are essential components, and the system 10 for recording or playing a SCADA scene to which a digital twin of a SCADA system is applied may be implemented with more components than the components illustrated in FIG. 1, or the system 10 for recording or playing a SCADA scene to which a digital twin of a SCADA system is applied may be implemented with fewer components than the components illustrated in FIG. 1.

The server 200 may be implemented in the form of a web server, a database server, a proxy server, etc. In addition, the server 200 may be installed with a network load distribution mechanism or one or more of various types of software that enables the server 200 to operate on the Internet or other networks, and thus may be implemented as a computerized system. In addition, the network may be an http network, a private line, an intranet, or any other network. Furthermore, the connection between the PLC 100, the server 200, and the database 300 may be connected to a secure network so that data is not attacked by any hacker or other third party. In addition, the server 200 may include a plurality of database servers, and the database servers may be implemented in a manner in which the database servers are separately connected to the server 200 through any type of network connection, including distributed database server architecture.

The PLC 100, the server 200, and the database 300 may each include a communication unit (not illustrated) for performing a communication function with other terminals, a storage unit (not illustrated) for storing various types of information and programs (or applications), a display unit (not illustrated) for displaying various types of information and program execution results, a voice output unit (not illustrated) for outputting voice information corresponding to the various types of information and program execution results, a control unit (not illustrated) for controlling various components and functions of each terminal, etc.

The PLC 100 communicates with the server 200, the database 300, etc. Here, the PLC 100 may be matched (or managed/controlled) one-to-one with one or more facilities (not illustrated) equipped (or deployed/installed) in an industrial site, or may be matched with multiple facilities in order to manage multiple facilities.

In addition, the PLC 100 collects (or receives) PLC data tags related to one or more facilities managed by the PLC 100. In this case, the PLC 100 may collect the PLC data tags related to the facility according to a preset cycle, a request of the server 200, etc.

In addition, the PLC 100 provides (or transmits) the PLC data tags related to one or more collected (or received) facilities, identification information of the PLC 100, etc., to the server 200. Here, the identification information of the PLC 100 includes mobile internet protocol (IP), mobile media access control (MAC), unique information, serial number, etc.

In addition, the PLC 100 receives PLC data request information transmitted from the server 200.

In addition, the PLC 100 collects one or more PLC data tags including state information of each facility for one or more facilities related to the PLC 100 based on the received PLC data request information, and transmits the collected one or more PLC data tags, the identification information of the PLC 100, etc., to the server 200. In this case, the PLC data tag including the state information of the facility is composed of various attributes related to the facility, including size, shape, color, rotation, movement, etc. Here, the identification information of the PLC 100 includes the mobile IP, the mobile MAC, the unique information, the serial number, etc.

In addition, the PLC 100 receives control information transmitted from the server 200.

In addition, the PLC 100 controls an operation (or management) of a specific facility based on the received control information, and generates a control result. Here, the control result includes a specific facility name (or facility unique number), control contents, control start time, control end time, etc.

In addition, the PLC 100 transmits the generated control result, the identification information of the PLC 100, etc., to the server 200.

The server 200 communicates with the PLC 100, the database 300, etc.

In addition, the server 200 performs functions as a central server that performs the overall control function of the system 10 while installed with SCADA software. Here, the SCADA software may be software used to manage PLC tag data (or tag data) together with software such as human machine interface (HMI) and man machine interface (MMI), and perform a Historian chart creating function using the PLC tag data, a report generation function, etc.

In addition, in the SCADA, the tag (or PLC data tag) represents elements that need to be monitored or controlled in the SCADA.

In addition, the tag (or PLC data tag) is divided into a digital tag and an analog tag.

The digital tag is used to monitor or control an operating state, etc., of a corresponding facility (or apparatus/device) according to a state of one bit data (e.g., high/low), such as an operating state (e.g., run/stop) of a pump or an on state (e.g., on/off) of a lamp.

In addition, the analog tag is used to represent continuously varying quantities, such as a water level, a flow rate, a voltage, and a current, which are converted into multiple bits of data such as byte (8 bits), word (16 bits), or double word (32 bits), to monitor or control an operational state of a facility (or apparatus/device). Here, the analog tag uses most of data within a range of about 5 digits including a decimal point. Since the analog tag should include the decimal point, the analog tag is stored (or managed) in the form of a floating point (double float).

In addition, the server 200 may classify, infer, and monitor the operational integrity of the SCADA system 10 and operator errors of an administrator based on all data managed by the server 200, using an artificial intelligence-based approach.

In addition, the server 200 may be composed of a main server (not illustrated) and a sub-server (not illustrated).

In this way, when configured in a redundant configuration with the server 200, the server 200 may perform functions such as switching a main server from an activated state (e.g., main server) to a deactivated state, and switching a sub-server from a deactivated state (e.g., sub-server) to an activated state, or vice versa, based on the result of abnormal state detection.

In addition, when configured in a redundant configuration with the server 200, the server 200 may simultaneously operate the main server and the sub-server by considering an operating rate (or CPU occupancy rate) of the server 200.

In addition, the server 200 manages a 3D digital twin model applied to a digital twin. Here, the server 200 applies a supervised learning algorithm of artificial intelligence to the 3D digital twin models, stores the 3D digital twin models to be recognized, and manages the 3D digital twin models by organizing the 3D digital twin models into a library.

That is, the server 200 trains a 3D digital twin model (or 3D object), which is pre-classified, through the supervised learning in the image recognition learning engine (or object recognition model to recognize objects on the server 200. Internally, the image recognition learning engine (or 3D engine) is rotated from multiple angles to capture and store the required images, thereby enabling the training that the target is an object to be recognized. When the training is completed, the 3D objects are stored in a library managed by the server 200 (or a database (not illustrated)), and are configured to be rendered in the scene when the image is recognized.

In addition, the 3D digital twin model trained by the server 200 uses convolution neural networks (CNNs) as the artificial intelligence image recognition technology algorithm to find a matching model in the library where the 3D digital twin model is stored for the object (or entity) recognized in the image.

In addition, the server 200 utilizes a plurality of pieces of image information, etc., collected in advance as data for continuous learning (or machine learning/deep learning). Here, the input dataset for training may be divided into a training set and a test set, in a predetermined ratio (including, for example, 7:3 or 8:2) using the plurality of image information and the like, so as to perform training and testing functions. In addition, the input data set for training includes the plurality of pieces of image information, etc., collected later. In addition, the output data set for training includes one or more objects (or facilities), etc., included in the corresponding image information, which are parts to be predicted, and are trained according to the plurality of pieces of image information, etc., and predicted later.

That is, the server 200 performs a training function to recognize (or classify/confirm) objects (or facilities) included in individual image information in relation to the corresponding image information, etc., according to the corresponding plurality of image information, etc., in relation to specific raw data through preset training data for an object recognition model (or an object classification/prediction model). In this case, the server 200 stores raw data (or including the plurality of pieces of image information, etc.) in parallel and in a distributed manner, refines unstructured data, structured data, and semi-structured data included in the stored raw data (or including training data, etc.), performs preprocessing including classification as metadata, performs analysis including data mining on the preprocessed data, and performs learning, training, and testing based on at least one type of machine learning, thereby building big data. In this case, at least one type of machine learning may be composed of one or at least one of supervised learning, semi-supervised learning, unsupervised learning, reinforcement learning, and deep reinforcement learning. The data mining may include performing classification to predict a class of new data by training a train data set whose class is known by exploring the inherent relationship between preprocessed data, or performing clustering to group data based on similarity without class information.

In this way, the server 200 performs a training function for the object recognition model (or object classification/prediction model) in the form of a neural network or an artificial neural network through the training data, etc.

In addition, the server 200 collects image information including one or more facilities located within a preset capturing area. In this case, the preset capturing area (or capturing area) may be any area (or zone) within a preset industrial site (e.g., including a factory, power generation system, etc.).

That is, a camera unit (not illustrated), which manages (or covers) the industrial site (or capturing area), acquires (or captures) image information including one or more facilities located within the capturing area, and transmits (or provides) the acquired (or captured) image information, the identification information of the camera unit, etc., to the server 200. Here, the identification information of the camera unit includes the mobile IP, the mobile MAC, the unique information, the serial number, etc. In this case, the PLC 100 may be matched (or managed/controlled) with one or more facilities one-to-one, or may be matched with multiple facilities.

In addition, the server 200 receives (or collects) the image information including one or more facilities transmitted from the camera unit, the identification information of the camera unit, etc.

In addition, the server 200 performs training (artificial neural network/machine learning/deep learning) for image analysis based on the artificial intelligence on the collected image information to recognize (or classify/confirm) one or more objects (or facilities) included in the corresponding image information based on the training result.

That is, the server 200 performs training (or artificial intelligence/machine learning/deep learning) using the collected image information, etc., as input values of a preset object recognition model (or object classification/prediction model) to recognize (or classify/confirm) one or more objects (or facilities) included in the corresponding image information based on the training result (or artificial intelligence result/machine training result/deep training result). In this case, the server 200 performs the preprocessing (or preprocessing function) on the collected image information, and then performs the artificial intelligence-based learning on the preprocessed image information (or image information on which the preprocessing function has been performed), and may recognize (or classify/confirm) one or more objects (or facilities) included in the corresponding image information based on the training result. Here, the preprocessing function includes a function for removing unnecessary areas (including, for example, borders, etc.) from the corresponding image information, a function for adjusting brightness (or luminance adjustment function), a function for adjusting sharpness, a function for adjusting creasing, a function for removing glare, etc.

In addition, when one or more objects are not recognized in the corresponding image information, the server 200 displays (or outputs) information indicating that the corresponding image information does not include an object.

In addition, the server 200 confirms a specific 3D digital twin model (or one or more 3D digital twin models) related to the recognized object (or one or more objects) among multiple 3D digital twin models pre-stored in the corresponding server 200 (or a library within the corresponding server 200/database (not illustrated)).

In the embodiment of the present invention, for the convenience of description, the recognized object is described as one, but it is not limited thereto, and when the server 200 recognizes multiple objects from the corresponding image information, the server 200 may confirm individual 3D digital twin models corresponding to each of the recognized multiple objects among multiple 3D digital twin models pre-stored in the corresponding server 200.

In addition, the server 200 searches for (or confirms) a specific PLC data tag (or one or more PLC data tags) related to the confirmed specific 3D specific twin model (or one or more 3D digital twin models) among a plurality of 3D digital twin models pre-stored in the server 200 (or another library in the server 200/database).

In addition, the server 200 connects (or matches/maps) the searched (or confirmed) specific PLC data tag to the confirmed specific 3D specific twin model.

That is, the server 200 connects (or matches/maps) the searched (or confirmed) specific PLC data tag to an attribute of the confirmed specific 3D specific twin model (or “<3D BODY>” of the confirmed specific 3D specific twin model) using an html document object model (DOM). Here, the server 200 may define the name of the specific PLC data tag and the name of each part of the specific 3D digital twin model in a pre-arranged (or set) format in order to connect the specific PLC data tag to the attributes of each part of the specific 3D digital twin model. In this case, the attributes of the specific 3D digital twin model include location, rotation, color, size, light source, etc., and may be set in various ways according to the designer's design, and may be set differently for each 3D digital twin model.

In addition, the server 200 generates (or implements/configures) a digital twin (or a 3D digital twin/digital twin environment) by performing 3D rendering based on the image information, the specific 3D digital twin model to which the specific PLC data tag is connected, etc.

In addition, the server 200 outputs (or displays/configures) the generated (or implemented/configured) digital twin (or the digital twin to which a specific 3D digital twin model corresponding to one or more objects included in the corresponding image information is applied) to the SCADA scene (or a SCADA application/software execution result scene) through the preset 3D engine (or by processing/using the 3D engine). In this case, the server 200 may output the generated digital twin to an app execution result scene (or the SCADA scene) on preset SCADA software.

In the embodiment of the present invention, the generation of the digital twin is mainly described in relation to one preset capturing area of the corresponding industrial site, but is not limited thereto, and the server 200 may also configure the digital twin for the entire (or part) of the corresponding industrial site by performing the above processes based on the plurality of pieces of image information collected from each of the plurality of capturing areas related to the corresponding industrial site.

In addition, the server 200 collects (or receives) the PLC data tags related to the facility, which is an object, from the PLC 100 corresponding to one or more objects included in the corresponding image information using the predetermined method (e.g., including JavaScript, etc.) at the preset cycle.

That is, the server 200 transmits PLC data request information related to a facility to the PLC 100 corresponding to one or more facilities (or objects) included in the corresponding image information using the predetermined method (e.g., JavaScript, etc.) at the preset cycle.

In addition, the server 200 receives the one or more PLC data tags, the identification information of the PLC 100, etc., transmitted from the PLC 100 in response to the previously transmitted PLC data request information.

In addition, the server 200 applies (or reflects/updates) the collected (or received) PLC data tags related to the corresponding facility to the attributes of the corresponding specific 3D digital twin model in the digital twin being output, using the html DOM, and displays (or outputs) the collected PLC data tags. In this case, the server 200 may accurately display the on-site situation as a scene that is easier to understand and more convenient to understand through changes in size, shape, color, rotation, movement, animation, etc., of a specific 3D digital twin model within the digital twin based on the PLC data tag related to the collected facility.

In this way, the server 200 may recognize the trained 3D digital twin model using the artificial intelligence image analysis algorithm, automatically display the corresponding object in the SCADA system (or the SCADA scene), and automatically connect the tag (TAG) connected to the attribute of the 3D digital twin model.

Through this, as the data connection method for dynamic change of the digital twin used in the existing industrial field, the data of the PLC 100 may be obtained by an automatic connection method of a tag, rather than a method of coding or manual work, so the changed animation by real-time data of the digital twin may be conveniently implemented.

In addition, the SCADA system 10 may be expected to reduce development manpower. That is, if the present invention is not adopted, developers with advanced programming skills would have to write code to develop a program that links PLC data tags with digital twin models. There are numerous and various equipment, facilities, and environments in the field, and a huge amount of development manpower is required to program all of these individually, but this may be solved through the configuration of the present invention.

In this way, the SCADA system 10 may be expected to save time and cost. That is, developing a program, coding, and implementing a function requires a lot of development manpower, and thus incurs costs. In addition, there are countless unspecified industrial fields, and there are so many types of equipment, facilities, and sensors used in the field. When all of these are developed according to the situation at that time, it takes a huge amount of time, and the cost increases proportionally. However, when the technical features of the present invention are used, this burden may be reduced.

In this way, the SCADA system 10 may accurately analyze and monitor the situation of the field by constructing the SCADA system using the artificial intelligence image recognition and 3D digital twin technology. It is difficult to express tag data from various sensors and measuring devices in the field controlled by the PLC 100 with image recognition alone. Therefore, the image recognition should be integrated with the digital twin technology to accurately capture the changes in data values, movements of equipment, and hidden internal changes that may not be identified through image alone, thereby enabling effective control and monitoring of the site.

In addition, the server 200 generates control information for controlling a specific facility among one or more facilities displayed on the corresponding digital twin according to administrator input (or administrator/user selection/touch/control).

That is, after the specific 3D digital twin model is selected among one or more 3D digital twin models included in the digital twin displayed on the corresponding server 200, the server 200 receives the input value (or the setting value) according to the administrator input.

In addition, the server 200 generates the control information (or control signal) including information on the selected specific 3D digital twin model (or information on a facility related to the specific 3D digital twin model), the received input value (or a setting value), etc.

In addition, the server 200 transmits the generated control information to the PLC 100 related to the specific facility.

In addition, the server 200 receives the control result transmitted from the PLC 100, the identification information of the PLC 100, etc., in response to the previously transmitted control information.

In addition, the server 200 displays (or outputs) the received control result, etc., on one side of the digital twin.

In addition, the server 200 may perform various functions (e.g., a 3D digital twin model creation and management function, a digital twin creation and management function, the communication function with a PLC, a PLC data tag collection function from a PLC, a function of applying the collected PLC data tag to the digital twin, etc.) by using the scene (or the SCADA scene) related to the corresponding SCADA software in the form of a dedicated app or a website.

In addition, while the server 200 outputs the corresponding SCADA scene, in the background state (or in parallel), one or more PLC data tags collected using a predetermined method (e.g., including JavaScript, etc.) from one or more (or multiple) PLCs 100 that are matched (or managed/controlled) one-to-one with one or more facilities, or matched with multiple facilities, at the preset cycle (or in real time), additional information collected in relation to the corresponding facility, etc., are temporarily stored in a buffer (or temporary buffer) in the form of a queue allocated to the database 300. Here, the additional information includes state information related to the corresponding PLC 100 (or operation state information of the corresponding PLC 100), current date and time information, information including temperature and humidity, etc., around the corresponding PLC 100 collected through a sensor unit (not illustrated), user information (e.g., including name, affiliation, position, employee number, etc.) currently operating the corresponding SCADA system, etc.

In this case, the capacity (or size) of the buffer (or temporary buffer) may be set to a capacity (or number of bytes) corresponding to the product of the number of PLC data tags collected in relation to the capturing area and a preset temporary storage time (for example, in units of seconds, including 300 seconds, 600 seconds, 1800 seconds, 3600 seconds, etc.), or may be set to a capacity corresponding to the product of the number of PLC data tags and the temporary storage time and a preset initial data capacity (for example, including 1 MB, 10 MB, 1 GB, etc.), or may be set to a capacity corresponding to a preset percentage (for example, including 5%, 10%, etc.) of the available capacity (or total capacity) of the database 300. Here, when the capacity of the buffer is set to the product of the number of PLC data tags and the temporary storage time, the default value (or basic unit) may be a predetermined state (for example, including 1 KB, 5 KB, 10 KB, etc.).

In addition, when the preset save button (or menu/item) displayed on one side of the SCADA scene being output (or displayed) on the server 200 is selected (or a preset save button configured on the server 200 is selected) based on the administrator selection (or administrator/operator/user input/touch/control) of the server 200, the server 200 confirms the preset storage method. In this case, the server 200 may receive the storage method according to the administrator input through the SCADA scene.

Here, the storage method includes a previous data storage method for storing information being stored in the buffer based on the time of selecting the save button, a subsequent data storage method for storing information being stored in an additional buffer based on the time of selecting the save button, an integrated data storage method for storing information being stored in the buffer and information being stored in the additional buffer together based on the time of selecting the save button, etc. In addition, the above-described previous data storage method is a method for storing the one or more PLC data tags, the additional information, etc., that are being stored in the buffer from the time before the selection of the save button to the time of selecting the save button. In addition, the above-described subsequent data storage method is a method for storing one or more PLC data tags, additional information, etc., being stored in the additional buffer from the selection of the save button to the selection of the end button, or during the preset additional storage time from the selection of the save button. In addition, the above-described integrated data storage method is a method for storing one or more PLC data tags, additional information, etc., being stored in the buffer from the time before the selection of the save button to the time of selecting the save button, and the one or more PLC data tags, the additional information, etc., being stored in the additional buffer from the selection of the save button to the selection of the end button or during the preset additional storage time, based on the selection of the save button.

In addition, when the above-described confirmed storage method is a previous data storage method, the server 200 stores page information including the one or more PLC data tags, the additional information, etc., that are collected and stored in the buffer at the preset cycle from the time before the selection of the save button to the time of selecting the save button, and information on the capturing area (or information on the capturing area related to the facility), one or more objects recognized in the image information (or information on the object/information on one or more objects recognized in the image information related to the facility), and information on the 3D digital twin model related to the SCADA scene, in the database 300. Here, the information on the 3D digital twin model related to the SCADA scene includes information on color, rotation, scale, and position change of the digital twin applied to the 3D digital twin model for each preset cycle (or in time units).

That is, when the confirmed storage method is a previous data storage method, the server 200 is linked with the database 300 to store, based on the time of selection of the save button, the one or more PLC data tags, the additional information, etc., which have been collected from a time before the selection of the save button to the time of selecting the save button and stored in the buffer at the preset cycle, the information on the capturing area, one or more objects (or information on the objects) recognized in the image information, the information on the 3D digital twin model related to the SCADA scene, etc., in the timelist table and page name universally unique identifier table (UUID) table allocated to the database 300 in the order in which they are stored in the database 300. In this case, when there is an error in some of the data stored in the buffer, the server 200 displays the information related to the error and stores the remaining data, excluding the data with the error, in the timelist table and page name UUID table allocated to the database 300 in a distributed manner in the order in which they are stored. Here, the image information collected in relation to the capturing area may be stored (or managed) in a separate distributed database server (or cloud server) (not illustrated).

In addition, after the data stored in the buffer is completed to be stored in the timelist table and page name UUID table allocated to the database 300, the server 200 is linked with the database 300 to initializes (or de-allocates) the allocated buffer.

In addition, the server 200 displays (or outputs) information indicating that the table storage of the data temporarily stored in the buffer is completed, error information, etc.

In addition, when the confirmed storage method is a subsequent data storage method, the server 200 is linked with the database 300 to allocate some of the storage space of the database 300, thereby configuring an additional buffer. In this case, the capacity (or size) of the additional buffer (or the temporary additional buffer) may be set to a capacity corresponding to a preset percentage (for example, including 5%, 10%, etc.) of the available capacity (or the total capacity) of the database 300, or may be set variably according to the storage time.

In addition, the server 200 temporarily stores the one or more PLC data tags collected from the one or more (or multiple) PLCs 100 at the preset cycle, the additional information collected in relation to the facility, etc., in the configured (or allocated) queue-type additional buffer (or additional temporary buffer) based on the time of selecting the save button, from the time of selecting the save button to the time of selecting the end button later or during the preset additional storage time.

In addition, when the end button is selected or the additional storage time has elapsed, the server 200 stores the page information including the one or more PLC data tags, the additional information, etc., being stored in the additional buffer, the information on the capturing area, one or more objects recognized in the image information (or information on the object), the information on the 3D digital twin model related to the SCADA scene, etc., in the database 300.

That is, when the end button is selected or when the additional storage time has elapsed, the server 200 is linked with the database 300 to store the one or more PLC data tags, the additional information, etc., being stored in the additional buffer, information on the corresponding capturing area, one or more objects (or information on the corresponding object) recognized from the corresponding image information, the information on the 3D digital twin model related to the corresponding SCADA scene, etc., in the timelist table and page name UUID table allocated to the database 300 in a distributed manner in the order in which they were stored in the database 300.

In addition, after the data stored in the additional buffer is completely stored in the timelist table and page name UUID table allocated to the database 300, the server 200 is linked with the database 300 to initialize (or de-allocate) the allocated buffer and the allocated additional buffer.

In addition, the server 200 displays (or outputs) information indicating that the table storage of the data temporarily stored in the additional buffer is completed, error information, etc.

In addition, when the confirmed storage method is an integrated data storage method, the server 200 is linked with the database 300 to allocate some of the storage space of the database 300, thereby configuring the additional buffer. In this case, the capacity of the additional buffer (or the temporary additional buffer) (or the size of the additional buffer) may be set to a capacity corresponding to a preset percentage (for example, including 5%, 10%, etc.) of the available capacity (or the total capacity) of the database 300, or may be set variably according to the storage time.

In addition, the server 200 temporarily stores the one or more PLC data tags collected from the one or more (or multiple) PLCs 100 at the preset cycle, the additional information collected in relation to the facility, etc., in the configured (or allocated) queue-type additional buffer (or additional temporary buffer) based on the time of selecting the save button, from the time of selecting the save button to the time of selecting the end button later or during the preset additional storage time.

In addition, when the end button is selected or when the additional save time has elapsed, the server 200 stores the page information including the one or more PLC data tags, the additional information, etc., which have been collected at the preset cycle from a time before the selection of the save button to the selection of the save button and are stored in the buffer, the one or more PLC data tags, the additional information, etc., which are stored in the additional buffer, the information on the capturing area, one or more objects recognized in the image information (or information on the objects), the information on the 3D digital twin model related to the SCADA scene, etc., in the database 300.

That is, when the end button is selected or when the additional save time has elapsed, the server 200 is linked with the database 300 to store, based on the time of selecting the save button, the one or more PLC data tags, the additional information, etc., being stored in the buffer from the time before the selection of the save button to the time of selecting the save button, the one or more PLC data tags, the additional information, etc., being stored in the additional buffer, the information on the capturing area, one or more objects (or information on the objects) recognized in the image information, the information on the 3D digital twin model related to the SCADA scene, etc., in the timelist table and page name UUID table allocated to the database 300 in the order in which they were stored in the database 300. In this case, when there is an error in some of the data stored in the buffer and/or the additional buffer, the server 200 displays the information related to the error and stores the remaining data excluding the data with the error in the timelist table and page name UUID table allocated to the database 300.

In addition, after the data stored in the buffer and the additional buffer are completed to be stored in the timelist table and the page name UUID table allocated to the database 300, the database 300 is linked with the server 200 to initialize (or de-allocates) the allocated buffer and the allocated additional buffer.

In addition, the server 200 displays (or outputs) information indicating that the table storage of the data temporarily stored in the buffer and/or the additional buffer is completed, error information, etc.

According to the embodiment of the present invention, based on the time of selecting the save button, the server 200 mainly describes storing information (or data) stored in the buffer, information (or data) stored in the additional buffer, and information (or data) stored in the buffer and the additional buffer in the database 300, but is not limited thereto. The server 200 may receive a storage period (for example, start date and time information to end date and time information) according to the administrator input, and may be configured to store the information collected at the preset cycle (or in units of the preset period of time) during the corresponding storage period in the database 300.

In addition, when a preset playback menu (or item/button) displayed on one side of an app execution result scene (or SCADA scene) on a preset SCADA software displayed on the server 200 is selected, the server 200 displays a file selection scene corresponding to the selected playback menu in order to provide one or more pieces of data stored in the database 300. Here, the file selection scene (or data selection scene/page selection scene/SCADA scene selection scene) includes a list including the information on the SCADA scene corresponding to the UUID related to one or more pieces of data stored in the database 300, information on the storage date and time, the information on the capturing area, etc. In this case, the server 200 may display the file selection scene in a pop-up form in the app execution result scene.

In this way, instead of the method of storing the SCADA scene in the form of an image file by linking the server 200 with the database 300, the data storage space may be saved by storing one or more pieces of data related to the SCADA scene.

That is, the general scene recording technology is an image recording method using scene image capture technology, and is stored in an image file format such as moving picture experts group part 4(mp4 ), windows media video (WMV), or audio image interleave (AVI). The compression technology of the image file itself is used, but as the scene becomes larger and the resolution increases, the size of the image file increases rapidly in proportion. In addition, with the recent spread of high-resolution 4K monitors, the resolution of the scene has increased rapidly, and in particular, multi-monitor scenes such as digital information display (DID) or digital light processing (DLP) used in the central monitoring room of industrial sites are burdened with large storage capacity when using the scene recording method. In addition, due to the nature of the industrial sites that operate 24 hours a day, 365 days a year, recording the scene using the image file storage method is even more burdensome in terms of storage space, which leads to a huge increase in cost.

However, when the scene is recorded through the technical configuration of the present invention, various types of information related to the SCADA scene may be recorded (or stored) without being affected by the size or resolution of the scene.

In addition, even when the monitor scene becomes larger or the resolution increases, only one digital twin is required, and only a basic page in a hypertext markup language (HTML) format is required. The rest requires only data such as PLC data tags that are stored in the database 300 in chronological order, so that storage space is consumed much less than that of the recorded image file. In this way, the present invention is suitable for industrial sites because it is not affected at all by the size or resolution of the scene.

In addition, according to the present invention, data before the start of image recording is saved.

In other words, when the image recording begins when an event or accident occurs, data analysis through image after the event has already occurred is likely to not include important data, so data critically important to analyze the causes of the event and accident is missed. This is because the cause and change in data that caused the event to occur should be known in order to analyze the cause. The present invention proposes a method for preserving data stored prior to the start of recording, thereby solving this problem.

In addition, when one of the SCADA scene information (or the information on the storage date and time/the information on the capturing area) corresponding to the UUID related to one or more pieces of data included in the list displayed in the file selection scene of the server 200 is selected, the server 200 is linked with the database 300 to retrieve (or load) the page information including the one or more PLC data tags, the additional information, the information on the capturing area, one or more objects recognized in the image information (or information on the objects), the information on the 3D digital twin model related to the SCADA scene, etc., being stored in chronological order in the database 300 in response to the information on the one or more SCADA scenes selected from the database 300. In this case, the server 200 retrieves (or loads) the page information including the one or more PLC data tags stored at the preset cycle (or in time units) from the database 300, the additional information, the information on the corresponding capturing area, one or more objects recognized in the corresponding image information (or information on the corresponding objects), the information on the 3D digital twin models related to the corresponding SCADA scene, etc.

In addition, the server 200 confirms the specific 3D digital twin model (or one or more 3D digital twin models) related to one or more objects loaded from among the plurality of 3D digital twin models pre-stored in the server 200 (or the library within the server 200/database 300).

In addition, the server 200 connects (or matches/maps) one or more retrieved (or loaded) PLC data tags to the confirmed specific 3D specific twin model.

That is, the server 200 connects (or matches/maps) the one or more retrieved (loaded) PLC data tags to the attributes of the confirmed specific 3D specific twin model (or “<3D BODY>” of the confirmed specific 3D specific twin model) using the HTML DOM. Here, the server 200 may define names of the one or more PLC data tags and names of the one or more parts of the one or more 3D digital twin models in the pre-agreed (or set) format in order to connect the one or more PLC data tags to the attributes of the respective parts of the respective specific 3D digital twin models. In this case, the attributes of the specific 3D digital twin model include location, rotation, color, size, light source, etc., and may be set in various ways according to the designer's design, and may be set differently for each 3D digital twin model.

In addition, the server 200 generates (or implements/configures) the digital twin (or the 3D digital twin/digital twin environment) by performing the 3D rendering based on the specific 3D digital twin model to which the one or more PLC data tags are connected, the additional information, etc. In this case, the server 200 may confirm (or load/retrieve) the image information related to the corresponding UUID among the plurality of pieces of image information (or the image information by UUID/capturing area unique ID) stored in a distributed database server (or cloud server), and may generate the digital twin by performing the 3D rendering based on the confirmed image information, the specific 3D digital twin model to which the one or more PLC data tags are connected, the additional information, etc.

In addition, the server 200 outputs (or displays) the generated (or implemented/configured) digital twin (or the digital twin to which the specific 3D digital twin model is applied) to the SCADA scene through the preset 3D engine. In this case, the server 200 may output the generated digital twin to an app execution result scene (or the SCADA scene) on preset SCADA software.

In this case, instead of using all the loaded data, the server 200 may 3D render the specific 3D digital twin model, such as the one or more PLC data tags, which are preset essential information among all the loaded data, to generate the digital twin (or the 3D digital twin/digital twin environment), and output the generated digital twin to the SCADA scene through the 3D engine. Here, the server 200 displays option selection information related to the loaded additional information in the form of a check box on one side of the SCADA scene.

In addition, when the check box of at least one option selection information (or component) among the option selection information related to the additional information displayed in the form of the check box is selected, the server 200 updates (or applies/reflects) information related to at least one option selection information corresponding to the selected check box to the digital twin, and outputs the updated digital twin to the SCADA scene through the 3D engine. Here, the information related to the at least one option selection information includes state information related to the corresponding PLC 100 (or operation state information of the corresponding PLC 100), current date and time information, information including temperature and humidity around the PLC 100, information (e.g., including name, affiliation, position, employee number, etc.) on a user currently operating the corresponding SCADA system, etc.

That is, when the check box of at least one option selection information (or component) among the additional information displayed in the form of the check box is selected, the server 200 adds (or inserts) data related to at least one option selection information corresponding to the selected check box to one side of the corresponding SCADA scene in the form of text and/or graph and displays the data.

In addition, when the check box of one or more pieces of option selection information (or components) among the option selection information related to the additional information displayed in the form of the check box is deselected, the server 200 controls data related to one or more pieces of option selection information corresponding to the selected check box to no longer be displayed in the corresponding SCADA scene.

In this way, the server 200 may control to display or not display one or more options according to the administrator's selection among the data displayed in the SCADA scene.

In addition, the server 200 performs event analysis, accident analysis, etc., at a specific time using the loaded data, and outputs the results according to the event analysis, accident analysis, etc.

In this way, instead of saving the SCADA scene as the image file such as avi or mpeg and then playing the saved image file, the server 200 stores multiple data (or information) related to the corresponding SCADA scene, loads the stored multiple data, and configures and outputs the SCADA scene using the multiple loaded data, thereby allowing the administrator to perform the event analysis, the accident analysis, etc., at a desired time.

In addition, in this way, the server 200 may connect the loaded data to the attributes of the digital twin model of the HTML page so that the digital twin model may reflect the data of the field. In this case, the server 200 may display some of the loaded data in the HTML scene instead of the digital twin model as a text structure and/or a graph structure.

In addition, the server 200 may update (or apply) the PLC data tag collected from the PLC 100 in real time in relation to the corresponding PLC data tag to the corresponding SCADA scene while outputting the SCADA scene using the loaded data, and output the updated SCADA scene.

In this way, the functional utilization of the digital twin may be possible when the present invention is played as the recorded scene.

That is, the existing method of recording a scene image using an image file is a method of capturing a 2D image of a scene and playing the 2D image continuously.

Therefore, when the scene of the field is switched from a scene required for actual analysis to another scene or the image or graph data display text to be confirmed is obscured by UI manipulation, etc., there is no way to confirm the data at that moment. When it is confirmed that a problem has occurred in the digital twin model, there is no way to find the detailed and precise cause of the problem by manipulating the digital twin model by zooming in, zooming out, rotating, etc.

In addition, when analyzing the event or accident, rather than analyzing only a single displayed data at that point in time, other data related to the analyzed event or accident should be analyzed together, and in this case, there is no way to implement this with only the recorded scene data.

The present invention, which solves these problems, uses the HTML DOM to load and play the PLC data tags, etc., stored in chronological order, from the database 300, so that the digital twin model may be freely manipulated by zooming in, zooming out, rotating, etc., during playback, and through this, hidden data and situations may be confirmed, and another additional PLC data tag for analyzing a certain event may be freely loaded and compared and confirmed.

In the embodiment of the present invention, it is mainly described that the server 200 selects the information stored in the database 300 and displays the selected information in the SCADA scene according to the administrator input (or administrator/operator selection/touch/control) managing the server 200, but is not limited thereto. Through the app execution result scene triggered by running the app or the website scene provided by the website, any terminal (not illustrated) utilizing the app or website provided by the server 200 may be configured to link with the server 200 and the database 300, select the information stored in the database 300, and display (or output) the SCADA scene in which the selected information is applied to the app execution result scene or the website scene displayed on the terminal.

The database 300 communicates with the PLC 100, the server 200, etc. Here, the database 300 may be configured as a database server, a distributed database server, etc.

In addition, the database 300 is linked with the server 200 to allocate a portion of the storage space within the database 300 as a buffer. In this case, the capacity (or size) of the buffer (or temporary buffer) may be set to a capacity (or number of bytes) corresponding to the product of the number of PLC data tags collected in relation to the capturing area and a preset temporary storage time (for example, in units of seconds, including 300 seconds, 600 seconds, 1800 seconds, 3600 seconds, etc.), or may be set to a capacity corresponding to the product of the number of PLC data tags and the temporary storage time and a preset initial data capacity (for example, including 1 MB, 10 MB, 1 GB, etc.), or may be set to a capacity corresponding to a preset percentage (for example, including 5%, 10%, etc.) of the available capacity (or total capacity) of the database 300. Here, when the capacity of the buffer is set to the product of the number of PLC data tags and the temporary storage time, the default value (or basic unit) may be a preset state (for example, including 1 KB, 5 KB, 10 KB, etc.).

In addition, the database 300 is linked with the server 200 to temporarily store the one or more PLC data tags collected from the server 200, the additional information collected in relation to the facility, etc., in the queue-type buffer (or temporary buffer) allocated to the database 300.

In this case, the database 300 allocates the timelist table and the page name UUID table to some of the storage spaces of the database 300 in relation to the SCADA scene (or page). Here, the database 300 manages (or creates) the timelist table and the page name UUID table for each SCADA scene (or page).

In addition, the database 300 stores (or records) the information (or data) stored in the buffer, the additional buffer, etc., in the allocated timelist table and the page name UUID table. Here, the timelist table is a table that manages the recording time of the overall page (or the SCADA scene), and is configured with multiple columns for storing (or managing) a page name (or SCADA scene information), a recording start time, a recording end time (or recording stop time), user information (e.g., including name, affiliation, position, employee number, etc.) currently operating the corresponding SCADA system, etc. In addition, the page name UUID table is configured with multiple columns for setting (or assigning) the universal unique identifier (UUID) to the page to be recorded, and storing (or managing) the one or more PLC data tags, the additional information, the information on the corresponding capturing area, one or more objects recognized in the corresponding image information (or information on the corresponding object), the information on the 3D digital twin model related to the corresponding SCADA scene, etc.

In addition, when the confirmed storage method is the subsequent data storage method or the integrated data storage method, the database 300 is linked with the server 200 to configure an additional buffer by allocating some of the storage space of the database 300. In this case, the capacity of the additional buffer (or the temporary additional buffer) (or the size of the additional buffer) may be set to a capacity corresponding to a preset percentage (for example, including 5%, 10%, etc.) of the available capacity (or the total capacity) of the database 300, or may be set variably according to the storage time.

In addition, the database 300 is linked with the server 200 to temporarily store the one or more PLC data tags collected from the one or more (or multiple) PLCs 100 at the preset cycle, the additional information collected in relation to the facility, etc., in the configured (or allocated) queue-type additional buffer (or additional temporary buffer) based on the time of selecting the save button, from the time of selecting the save button to the time of selecting the end button later or during the preset additional storage time.

In addition, when the end button is selected or the additional storage time has elapsed, the database 300 is linked with the server 200 to store the page information including the one or more PLC data tags, the additional information, etc., being stored in the additional buffer, the information on the capturing area, one or more objects recognized in the image information (or information on the object), the information on the 3D digital twin model related to the SCADA scene, etc., in the database 300.

That is, in the state where the confirmed storage method is the subsequent data storage method, when the end button is selected or when the additional storage time has elapsed, the server 200 is linked with the database 300 and stores the one or more PLC data tags, the additional information, etc., being stored in the additional buffer, information on the corresponding capturing area, one or more objects (or information on the corresponding object) recognized from the corresponding image information, the information on the 3D digital twin model related to the corresponding SCADA scene, etc., in the time list table and page name UUID table allocated to the database 300 in the order in which they were stored in the database 300.

In addition, after the data stored in the additional buffer is completed in the time list table and page name UUID table allocated to the database 300, the database 300 is linked with the server 200 to initialize (or de-allocate) the allocated buffer and the allocated additional buffer.

In addition, when the end button is selected or when the additional save time has elapsed, the database 300 is linked with the server 200 to store the page information including the one or more PLC data tags, the additional information, etc., which have been collected at the preset cycle from a time before the selection of the save button to the selection of the save button and are stored in the buffer, the one or more PLC data tags, the additional information, etc., which are stored in the additional buffer, the information on the capturing area, one or more objects recognized in the image information (or information on the objects), the information on the 3D digital twin model related to the SCADA scene, etc., in the database 300.

That is, in the state where the confirmed storage method is the integrated data storage method, when the end button is selected or when the additional save time has elapsed, the database 300 is linked with the server 200 to store, based on the time of selecting the save button, the one or more PLC data tags, the additional information, etc., being stored in the buffer from the time before the selection of the save button to the time of selecting the save button, the one or more PLC data tags, the additional information, etc., being stored in the additional buffer, the information on the capturing area, one or more objects (or information on the objects) recognized in the image information, the information on the 3D digital twin model related to the SCADA scene, etc., in the time list table and page name UUID table allocated to the database 300 in the order in which they were stored in the database 300. In this case, when there is an error in some of the data stored in the buffer and/or the additional buffer, the server 200 displays the information related to the error and stores the remaining data excluding the data with the error in the time list table and page name UUID table allocated to the database 300.

In addition, after the data stored in the buffer and the additional buffer are completed to be stored in the time list table and the page name UUID table allocated to the database 300, the database 300 is linked with the server 200 to initialize (or de-allocates) the allocated buffer and the allocated additional buffer.

In addition, the database 300 provides the server 200 with the page information including the one or more PLC data tags, the additional information, the information on the capturing area, one or more objects recognized in the image information (or information on the object), the information on the 3D digital twin model related to the SCADA scene, etc., being stored in chronological order in the database 300 in response to information on one SCADA scene selected from the server 200 according to a request (or control) of the server 200.

In this way, the PLC data tags collected in real time from PLC are applied to the 3D digital twin model and displayed as the SCADA scene, and the collected PLC data tags, the additional information, etc., are stored in the buffer allocated to the database, and when the preset recording button according to the user selection is selected, the data stored in the buffer according to the preset storage method, the data stored in an additional buffer for the preset period of time from the time of selecting the recording button, etc., may be stored in the database.

In addition, in this way, when specific data is selected according to user selection from among data including the one or more PLC data tags stored in the database, the PLC data tags, the additional information, etc., related to the selected specific data may be played in the SCADA scene.

Hereinafter, a method of recording or playing a SCADA scene to which a digital twin of a SCADA system is applied according to the present invention will be described in detail with reference to FIGS. 1 to 3.

FIG. 2 is a flowchart illustrating a method of recording or playing a SCADA scene to which a digital twin of a SCADA system is applied according to a first embodiment of the present invention.

First, the server 200 outputs (or displays) the 3D digital twin model connected to the one or more PLC data tags collected from the PLC 100 corresponding to one or more facilities located within the preset capturing area (or capturing area) of the industrial site to the SCADA scene through the preset 3D engine.

That is, the server 200 collects the image information including one or more facilities located within the preset capturing area (or filming area) of the industrial site.

In addition, the server 200 performs training (artificial neural network/machine learning/deep learning) for image analysis based on the artificial intelligence on the collected image information to recognize (or classify/confirm) one or more objects (or facilities) included in the corresponding image information based on the training result.

In addition, the server 200 confirms the specific 3D digital twin model (or one or more 3D digital twin models) related to the recognized object (or one or more objects) among multiple 3D digital twin models pre-stored in the corresponding server 200 (or a library within the corresponding server 200/database 300).

In addition, the server 200 searches for (or confirms) a specific PLC data tag (or one or more PLC data tags) related to the confirmed specific 3D specific twin model (or one or more 3D digital twin models) among a plurality of 3D digital twin models pre-stored in the server 200 (or another library in the server 200/database 300).

In addition, the server 200 connects (or matches/maps) the searched (or confirmed) specific PLC data tag to the confirmed specific 3D specific twin model.

In addition, the server 200 generates (or implements/configures) a digital twin (or a 3D digital twin/digital twin environment) by performing 3D rendering based on the image information, the specific 3D digital twin model to which the specific PLC data tag is connected, etc.

In addition, the server 200 generates (or implements/configures) the digital twin (or a 3D digital twin/digital twin environment) by performing the 3D rendering based on the image information, the specific 3D digital twin model to which the specific PLC data tag is connected, etc. In this case, the server 200 may output the generated digital twin to an app execution result scene (or the SCADA scene) on preset SCADA software.

For example, the server 200 performs training by using first image information including a first generator and a first pump acquired from a first camera unit (not illustrated) covering a first capturing area within the preset factory A as the input values of the preset object recognition model to recognize the first generator and the first pump included in the corresponding first image information based on the training result.

In addition, the server 200 confirms a 101st 3D digital twin model corresponding to the recognized first generator and a 201st 3D digital twin model corresponding to the recognized first pump among each of the plurality of 3D digital twin models pre-stored in the server 200.

In addition, the server 200 searches for the 101st PLC data tag related to the confirmed 101st 3D digital twin model among the plurality of 3D digital twin models pre-stored in the server 200, and searches for the 201st PLC data tag related to the confirmed 201st 3D digital twin model.

In addition, the server 200 connects the searched 101st PLC data tag to a plurality of attributes of the 101st 3D digital twin model, respectively, using the html DOM, and connects the searched 201st PLC data tag to each of the plurality of attributes of the 201st 3D digital twin model.

In addition, the server 200 generates a first digital twin based on the first image information, the 101st 3D digital twin model connected to the 101st PLC data tag, the 201st 3D digital twin model connected to the 201st PLC data tag, etc.

In addition, the server 200 displays the first digital twin generated in relation to the first capturing area within the factory A on the SCADA scene through the 3D engine (S210).

In addition, while the server 200 outputs the corresponding SCADA scene, in the background state (or in parallel), one or more PLC data tags collected using a predetermined method (e.g., including JavaScript, etc.) from one or more (or multiple) PLCs 100 that are matched (or managed/controlled) one-to-one with one or more facilities, or matched with multiple facilities, at the preset cycle (or in real time), additional information collected in relation to the corresponding facility, etc., are temporarily stored in a buffer (or temporary buffer) in the form of a queue allocated to the database 300. Here, the additional information includes state information related to the corresponding PLC 100 (or operation state information of the corresponding PLC 100), current date and time information, information including temperature and humidity, etc., around the corresponding PLC 100 collected through a sensor unit (not illustrated), user information (e.g., including name, affiliation, position, employee number, etc.) currently operating the corresponding SCADA system, etc.

In this case, the capacity (or size) of the buffer (or temporary buffer) may be set to a capacity (or number of bytes) corresponding to the product of the number of PLC data tags collected in relation to the capturing area and a preset temporary storage time (for example, in units of seconds, including 300 seconds, 600 seconds, 1800 seconds, 3600 seconds, etc.), or may be set to a capacity corresponding to the product of the number of PLC data tags and the temporary storage time and a preset initial data capacity (for example, including 1 MB, 10 MB, 1 GB, etc.), or may be set to a capacity corresponding to a preset percentage (for example, including 5%, 10%, etc.) of the available capacity (or total capacity) of the database 300. Here, when the capacity of the buffer is set to the product of the number of PLC data tags and the temporary storage time, the default value (or basic unit) may be a preset state (for example, including 1 KB, 5 KB, 10 KB, etc.).

For example, the server 200 is linked with the database 300 to configure, in the database 300, a first buffer set with a first capacity (e.g., 2*3600 seconds* 10 KB=72,000 Kbytes) corresponding to the product of the number (e.g., 2) of PLC data tags collected in relation to the first capturing area and the preset temporary storage time (e.g., 3600 seconds).

In addition, the server 200 temporarily stores first PLC data tags or second PLC data tags collected in relation to the first capturing area, the temperature and humidity around the first capturing area, the state information of the first PLC 100 or the state information of the second PLC 100, the current date and time information, the first user information operating the SCADA system, etc., in the configured queue-type first buffer (S220).

Thereafter, when the preset save button (or menu/item) displayed on one side of the SCADA scene being output (or displayed) on the server 200 is selected (or a preset save button configured on the server 200 is selected) based on the administrator selection (or administrator/operator/user input/touch/control) of the server 200, the server 200 confirms the preset storage method. In this case, the server 200 may receive the storage method according to the administrator input through the SCADA scene.

Here, the storage method includes a previous data storage method for storing information being stored in the buffer based on the time of selecting the save button, a subsequent data storage method for storing information being stored in an additional buffer based on the time of selecting the save button, an integrated data storage method for storing information being stored in the buffer and information being stored in the additional buffer together based on the time of selecting the save button, etc. In addition, the above-described previous data storage method is a method for storing the one or more PLC data tags, the additional information, etc., that are being stored in the buffer from the time before the selection of the save button to the selection of the save button. In addition, the above-described subsequent data storage method is a method for storing one or more PLC data tags, additional information, etc., being stored in the additional buffer from the selection of the save button to the selection of the end button, or during the preset additional storage time from the selection of the save button. In addition, the above-described integrated data storage method is a method for storing one or more PLC data tags, additional information, etc., being stored in the buffer from the time before the selection of the save button to the selection of the save button, and the one or more PLC data tags, the additional information, etc., being stored in the additional buffer from the selection of the save button to the selection of the end button or during the preset additional storage time, based on the selection of the save button.

For example, when the save button displayed on one side of the SCADA scene is selected, the server 200 confirms the storage method stored in the server 200 (S230).

Thereafter, when the confirmed storage method is the previous data storage method, the server 200 stores the page information including the one or more PLC data tags, the additional information, etc., which are collected at the preset cycle from the time before the selection of the save button to the selection of the save button and stored in the buffer, the information on the capturing area, one or more objects recognized in the image information (or the information on the object), the information on the 3D digital twin model related to the SCADA scene, etc., in the database 300.

That is, when the confirmed storage method is a previous data storage method, the server 200 is linked with the database 300 to store, based on the time of selection of the save button, the one or more PLC data tags, the additional information, etc., which have been collected from the time before the selection of the save button to the time of selecting the save button and stored in the buffer at the preset cycle, the information on the capturing area, one or more objects (or information on the objects) recognized in the image information, the information on the 3D digital twin model related to the SCADA scene, etc., in the timelist table and page name universally unique identifier table (UUID) table allocated to the database 300 in the order in which they are stored in the database 300. In this case, when there is an error in some of the data stored in the buffer, the server 200 displays the information related to the error and stores the remaining data, excluding the data with the error, in the time list table and page name UUID table allocated to the database 300 in the order in which they are stored. Here, the image information collected in relation to the capturing area may be stored (or managed) in a separate distributed database server (or cloud server) (not illustrated).

In addition, after the data stored in the buffer is completed to be stored in the time list table and page name UUID table allocated to the database 300, the server 200 is linked with the database 300 to initialize (or de-allocate) the allocated buffer.

In addition, the server 200 displays (or outputs) information indicating that the table storage of the data temporarily stored in the buffer is completed, error information, etc.

For example, when the confirmed storage method is the previous data storage method, the server 200 is linked with the database 300 to store about 3600 seconds of the first PLC data tag or the second PLC data tag temporarily stored in the first buffer of the database 300, the temperature and humidity around the first capturing area, the state information of the first PLC or the state information of the second PLC, first user information operating the SCADA system, the information on the first capturing area, the information on the first generator, the information on the first pump, the information on the first 3D digital twin model, etc., in the first timelist table and the first page name UUID table allocated to the database 300, respectively.

In addition, after the data of the first buffer temporarily stored in the database 300 is stored in the first timelist table and the first page name UUID table, the server 200 is linked with the database 300 to initialize the first buffer (S240).

In addition, when the confirmed storage method is a subsequent data storage method, the server 200 is linked with the database 300 to allocate some of the storage space of the database 300, thereby configuring the additional buffer. In this case, the capacity of the additional buffer (or the temporary additional buffer) (or the size of the additional buffer) may be set to a capacity corresponding to a preset percentage (for example, including 5%, 10%, etc.) of the available capacity (or the total capacity) of the database 300, or may be set variably according to the storage time.

In addition, the server 200 temporarily stores the one or more PLC data tags collected from the one or more (or multiple) PLCs 100 at the preset cycle, the additional information collected in relation to the facility, etc., in the configured (or allocated) queue-type additional buffer (or additional temporary buffer) based on the time of selecting the save button, from the time of selecting the save button to the time of selecting the end button later or during the preset additional storage time.

In addition, when the end button is selected or the additional storage time has elapsed, the server 200 stores the page information including the one or more PLC data tags, the additional information, etc., being stored in the additional buffer, the information on the capturing area, one or more objects recognized in the image information (or information on the object), the information on the 3D digital twin model related to the SCADA scene, etc., in the database 300.

That is, when the end button is selected or when the additional storage time has elapsed, the server 200 is linked with the database 300 and stores the one or more PLC data tags, the additional information, etc., being stored in the additional buffer, information on the corresponding capturing area, one or more objects (or information on the corresponding object) recognized from the corresponding image information, the information on the 3D digital twin model related to the corresponding SCADA scene, etc., in the time list table and page name UUID table allocated to the database 300 in the order in which they were stored in the database 300.

In addition, after the data stored in the additional buffer is completed in the time list table and page name UUID table allocated to the database 300, the server 200 is linked with the database 300 to initialize (or de-allocate) the allocated buffer and the allocated additional buffer.

In addition, the server 200 displays (or outputs) information indicating that the table storage of the data temporarily stored in the additional buffer is completed, error information, etc.

For example, when the confirmed storage method is the subsequent data storage method, the server 200 is linked with the database 300 to configure a second additional buffer.

In addition, the server 200 temporarily stores the first PLC data tag or the second PLC data tag collected in relation to the first capturing area from the time of selecting the save button, the temperature and humidity around the first capturing area, the state information of the first PLC or the state information of the second PLC, the current date and time information, the first user information operating the SCADA system, etc., in the configured queue-type second additional buffer.

In addition, when the end button is selected, the server 200 is linked with the database 300 to store about 1800 seconds of the first PLC data tag or the second PLC data tag temporarily stored in the second additional buffer of the database 300, the temperature and humidity around the first capturing area, the state information of the first PLC or the state information of the second PLC, the first user information operating the SCADA system, the information on the first capturing area, the information on the first generator, the information on the first pump, the information on the first 3D digital twin model, etc., in the second timelist table and the second page name UUID table allocated to the database 300, respectively.

In addition, after the data of the second additional buffer temporarily stored in the database 300 is stored in the second timelist table and the second page name UUID table, the server 200 is linked with the database 300 to initialize the first buffer and the second additional buffer (S250).

In addition, when the confirmed storage method is an integrated data storage method, the server 200 is linked with the database 300 to allocate some of the storage space of the database 300, thereby configuring the additional buffer. In this case, the capacity of the additional buffer (or the temporary additional buffer) (or the size of the additional buffer) may be set to a capacity corresponding to a preset percentage (for example, including 5%, 10%, etc.) of the available capacity (or the total capacity) of the database 300, or may be set variably according to the storage time.

In addition, the server 200 temporarily stores the one or more PLC data tags collected from the one or more (or multiple) PLCs 100 at the preset cycle, the additional information collected in relation to the facility, etc., in the configured (or allocated) queue-type additional buffer (or additional temporary buffer) based on the time of selecting the save button, from the time of selecting the save button to the time of selecting the end button later or during the preset additional storage time.

In addition, when the end button is selected or when the additional save time has elapsed, the server 200 stores the page information including the one or more PLC data tags, the additional information, etc., which have been collected at the preset cycle from the time before the selection of the save button to the selection of the save button and are stored in the buffer, the one or more PLC data tags, the additional information, etc., which are stored in the additional buffer, the information on the capturing area, one or more objects recognized in the image information (or information on the objects), the information on the 3D digital twin model related to the SCADA scene, etc., in the database 300.

That is, when the end button is selected or when the additional save time has elapsed, the server 200 is linked with the database 300 to store, based on the time of selecting the save button, the one or more PLC data tags, the additional information, etc., being stored in the buffer from the time before the selection of the save button to the time of selecting the save button, the one or more PLC data tags, the additional information, etc., being stored in the additional buffer, the information on the capturing area, one or more objects (or information on the objects) recognized in the image information, the information on the 3D digital twin model related to the SCADA scene, etc., in the timelist table and page name UUID table allocated to the database 300 in the order in which they were stored in the database 300. In this case, when there is an error in some of the data stored in the buffer and/or the additional buffer, the server 200 displays the information related to the error and stores the remaining data excluding the data with the error in the time list table and page name UUID table allocated to the database 300.

In addition, after the data stored in the buffer and the additional buffer are completed to be stored in the time list table and the page name UUID table allocated to the database 300, the server 200 is linked with the server 200 to initialize (or de-allocate) the allocated buffer and the allocated additional buffer.

In addition, the server 200 displays (or outputs) information indicating that the table storage of the data temporarily stored in the buffer and/or the additional buffer is completed, error information, etc.

For example, when the confirmed storage method is the integrated data storage method, the server 200 is linked with the database 300 to configure a third additional buffer.

In addition, the server 200 temporarily stores the first PLC data tag or the second PLC data tag collected in relation to the first capturing area from the time of selecting the save button, the temperature and humidity around the first capturing area, the state information of the first PLC or the state information of the second PLC, the current date and time information, the first user information operating the SCADA system, etc., in the configured queue-type third additional buffer.

In addition, when the preset additional storage time (e.g., 5400 seconds) elapses, the server 200 is linked with the database 300 to store about 3600 seconds of the first PLC data tag to the second PLC data tag temporarily stored in the first buffer of the database 300, the temperature and humidity around the first capturing area, the state information of the first PLC to the state information of the second PLC, the first user information operating the SCADA system, etc., and about 5400 seconds of the first PLC data tag to the second PLC data tag temporarily stored in the third additional buffer, the temperature and humidity around the first capturing area, the state information of the first PLC to the state information of the second PLC, etc., the first user information operating the SCADA system, the information on the first capturing area, information on the first generator, the information on the first pump, the information on the first 3D digital twin model, etc., in a third timelist table and a third page name UUID table allocated to the database 300.

In addition, after the data of the first buffer and the third additional buffer temporarily stored in the database 300 are stored in the third timelist table and the third page name UUID table, the server 200 is linked with the database 300 to initialize the first buffer and the third additional buffer (S260).

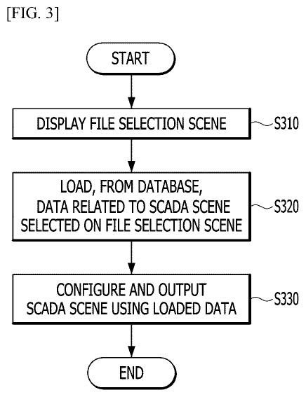

FIG. 3 is a flowchart illustrating a method of recording or playing a SCADA scene to which a digital twin of a SCADA system is applied according to a second embodiment of the present invention.

First, when the preset playback menu (or item/button) displayed on one side of an app execution result scene (or SCADA scene) on a preset SCADA software displayed on the server 200 is selected, the server 200 displays a file selection scene corresponding to the selected playback menu in order to provide one or more pieces of data stored in the database 300. Here, the file selection scene (or data selection scene) includes the list including information on the SCADA scene corresponding to the UUID related to one or more pieces of data stored in the database 300, the information on the storage date and time, the information on the capturing area, etc. In this case, the server 200 may display the file selection scene in a pop-up form in the app execution result scene.

For example, when the playback menu displayed on one side of the SCADA scene, which is the app execution result scene, is selected after the SCADA app installed in the server 200 is executed, the server 200 is linked with the database 300 to display the file selection scene including a first list including information related to a first UUID to a fifth UUID stored in the database 300 in a pop-up form (S310).

Thereafter, when one of the SCADA scene information (or the information on the storage date and time/the information on the capturing area) corresponding to the UUID related to one or more pieces of data included in the list displayed in the file selection scene of the server 200 is selected, the server 200 is linked with the database 300 and searches for (or loads) the page information including the one or more PLC data tags, the additional information, the information on the capturing area, one or more objects recognized in the image information (or information on the objects), the information on the 3D digital twin model related to the SCADA scene, etc., being stored in chronological order in the database 300 in response to the information on the one or more SCADA scenes selected from the database 300. In this case, the server 200 loads the page information including the one or more PLC data tags stored at the preset cycle (or in time units) from the database 300, the additional information, the information on the corresponding capturing area, one or more objects recognized in the corresponding image information (or information on the corresponding objects), the information on the 3D digital twin models related to the corresponding SCADA scene, etc.

In addition, the server 200 confirms the specific 3D digital twin model (or one or more 3D digital twin models) related to one or more loaded objects among the plurality of 3D digital twin models pre-stored in the server 200 (or the library within the server 200/database 300).

In addition, the server 200 connects (or matches/maps) one or more loaded PLC data tags to the confirmed specific 3D specific twin model.

That is, the server 200 connects (or matches/maps) the one or more PLC data tags that have been loaded to the attributes of the confirmed specific 3D specific twin model (or “<3D BODY>” of the confirmed specific 3D specific twin model) using the HTML DOM. Here, the server 200 may define names of the one or more PLC data tags and names of the one or more parts of the one or more 3D digital twin models in the pre-agreed (or set) format in order to connect the one or more PLC data tags to the attributes of the respective parts of the respective specific 3D digital twin models. In this case, the attributes of the specific 3D digital twin model include location, rotation, color, size, light source, etc., and may be set in various ways according to the designer's design, and may be set differently for each 3D digital twin model.

For example, when information related to the third UUID is selected from among information related to the first UUID to the fifth UUID included in the first list displayed in the file selection scene of the server 200, the server 200 is linked with the database 300 to load, in response to the information related to the selected third UUID, about 3600 seconds of the first PLC data tag to the second PLC data tag, the temperature and humidity around the first capturing area, the state information of the first PLC 100 to the second PLC 100, the information on the first user operating the SCADA system, etc., which are being stored in the third timelist table and the third page name UUID table, respectively, in the database 300, and about 5400 seconds of the first PLC data tag to the second PLC data tag, the temperature and humidity around the first capturing area, the state information of the first PLC to the second PLC, the information on the first user operating the SCADA system, etc., and the first page information including the user information, the information on the first capturing area, the information on the first generator, the information on the first pump, the information on the first 3D digital twin model, etc.

In addition, the server 200 confirms the 101st 3D digital twin model corresponding to the loaded information on the first generator and the 201st 3D digital twin model corresponding to the loaded information on the first pump among the multiple 3D digital twin models pre-stored in the server 200.

In addition, the server 200 connects the loaded first PLC data tag to each of the multiple attributes of the 101st 3D digital twin model using the html DOM, and connects the loaded second PLC data tag to each of the multiple attributes of the 201st 3D digital twin model (S320).

Thereafter, the server 200 generates (or implements/configures) the digital twin (or the 3D digital twin/digital twin environment) by performing the 3D rendering based on the specific 3D digital twin model to which the one or more PLC data tags are connected, the additional information, etc. In this case, the server 200 may confirm (or load/invoke) the image information related to the corresponding UUID among the plurality of pieces of image information (or the image information by UUID/capturing area unique ID) stored in the distributed database server (or cloud server), and may generate the digital twin by performing the 3D rendering based on the confirmed image information, the specific 3D digital twin model to which the one or more PLC data tags are connected, the additional information, etc.

In addition, the server 200 outputs (or displays) the generated (or implemented/configured) digital twin (or the digital twin to which the specific 3D digital twin model is applied) to the SCADA scene through the preset 3D engine. In this case, the server 200 may output the generated digital twin to an app execution result scene (or the SCADA scene) on preset SCADA software.

In this case, instead of using all the loaded data, the server 200 may 3D render the specific 3D digital twin model, such as the one or more PLC data tags, which are preset essential information among all the loaded data, to generate the digital twin (or the 3D digital twin/digital twin environment), and output the generated digital twin to the SCADA scene through the 3D engine. Here, the server 200 displays option selection information related to the loaded additional information in the form of a check box on one side of the SCADA scene.

In addition, when the check box of at least one option selection information (or component) among the option selection information related to the additional information displayed in the form of the check box is selected, the server 200 updates (or applies/reflects) information related to at least one option selection information corresponding to the selected check box to the digital twin, and outputs the updated digital twin to the SCADA scene through the 3D engine. Here, the information related to the at least one option selection information includes state information related to the corresponding PLC 100 (or operation state information of the corresponding PLC 100), current date and time information, information including temperature and humidity around the PLC 100, information (e.g., including name, affiliation, position, employee number, etc.) on a user currently operating the corresponding SCADA system, etc.

That is, when the check box of at least one option selection information (or component) among the additional information displayed in the form of the check box is selected, the server 200 adds (or inserts) data related to at least one option selection information corresponding to the selected check box to one side of the corresponding SCADA scene in the form of text and/or graph and displays the data.

For example, the server 200 generates the first digital twin based on the 101st 3D digital twin model to which the first PLC data tag is connected, the 201st 3D digital twin model to which the second PLC data tag is connected, the additional information, etc.

In addition, the server 200 displays the first digital twin generated in relation to the first capturing area within the factory A on the SCADA scene through the 3D engine (S330).

As described above, according to the embodiment of the present invention, the programmable logic controller (PLC) data tags collected in real time from the PLC are applied to the 3D digital twin model to display the PLC data tags as the supervisory control and data acquisition (SCADA) scene, and the collected PLC data tags, the additional information, etc., are stored in the buffer allocated to the database, and the data stored in the buffer according to the preset storage method when the preset recording button according to the user selection is selected, the data stored in the additional buffer during the preset period of time from the time when the recording button is selected, etc., are stored in the database, thereby improving operational efficiency of the database by storing related data without being affected by a size, a resolution, etc., of the SCADA scene, and preserving the related data before and after an event occurs.

In addition, as described above, according to the present invention, when the specific data is selected according to the user selection from among data including one or more PLC data tags, etc., stored in the database, by playing, in the SCADA scene, the PLC data tags, the additional information, etc., related to the selected specific data, it is possible to freely control the digital twin model by zooming in, zooming out, rotating, etc., the PLC data tags, etc., by loading the PLC data tags, etc., stored in chronological order using the HTML DOM and playing the PLC data tags, etc., selectively apply the additional information, etc., to the digital twin model to display the additional information, etc., and compare, confirm, analyze, etc., the additional information by freely loading the PLC data, the additional information, etc., for analyzing the event.

According to the present invention, by applying the programmable logic controller (PLC) data tags collected in real time from the PLC to the 3D digital twin model to display the PLC data tags as the supervisory control and data acquisition (SCADA) scene, storing the collected PLC data tags, the additional information, etc., in the buffer allocated to the database, and storing, in the database, the data stored in the buffer according to the preset storage method when the preset recording button according to the user selection is selected, the data stored in the additional buffer during the preset period of time from the time of selecting the recording button, etc., it is possible to improve the operational efficiency of the database by storing the related data without being affected by the size, a resolution, etc., of the SCADA scene, and preserve the related data before and after the event occurs.

In addition, according to the present invention, when the specific data is selected according to the user selection from among data including one or more PLC data tags, etc., being stored in the database, by playing, in the SCADA scene, the PLC data tags, the additional information, etc., related to the selected specific data, it is possible to freely control the digital twin model by zooming in, zooming out, rotating, etc., the PLC data tags, etc., by loading the PLC data tags, etc., being stored in chronological order using the HTML DOM and playing the PLC data tags, etc., selectively apply the additional information, etc., to the digital twin model to display the additional information, etc., and compare, confirm, analyze, etc., the additional information by freely loading the PLC data, the additional information, etc., for analyzing the event.

The above-described content can be modified and modified by a person having ordinary skill in the art to which the present invention pertains without departing from the essential characteristics of the present invention. Accordingly, exemplary embodiments disclosed in the present invention are not to limit the spirit of the present invention, but are to describe the spirit of the present invention. The scope of the present invention is not limited to these exemplary embodiments. The scope of the present invention should be interpreted by the following claims and it should be interpreted that all spirits equivalent to the following claims fall within the scope of the present invention.

What is claimed is:

1. A system for recording or playing a supervisory control and data acquisition (SCADA) scene to which a digital twin of a SCADA system is applied, the system comprising:
a database configured to allocate a buffer for temporarily storing data; and
a server configured to output a three-dimensional (3D) digital twin model connected to one or more programmable logic controller (PLC) data tags collected from a PLC corresponding to a facility on the SCADA scene, store the one or more PLC data tags collected from the PLC using a predetermined method at a preset cycle and additional information collected in relation to the facility in the buffer allocated to the database, when a preset save button displayed on one side of the SCADA scene is selected, confirm a preset storage method, when the confirmed storage method is an integrated data storage method, allocate a portion of the storage space of the database by linking with the database to configure an additional buffer, based on a time of selecting the save button, store the one or more PLC data tags collected from one or more PLCs at the preset cycle and the additional information collected in relation to the facility in the additional buffer from the time of selecting the save button to a time of selecting an end button later or during a preset additional save time, and when the end button is selected or the additional save time has elapsed, based on the time of selecting the save button, store, in a timelist table and a page name universally unique identifier table (UUID) table allocated to the database, page information that includes the one or more PLC data tags and the additional information collected and stored in the buffer at the preset cycle from a time before the selection of the save button to the time of selecting the save button, the one or more PLC data tags and the additional information being stored in the additional buffer, information on a capturing area related to the equipment, one or more objects recognized from image information related to the facility, and information on the 3D digital twin model related to the SCADA scene.

2. The system of claim 1, wherein the SCADA scene performs artificial intelligence-based learning based on image information including one or more facilities located within the preset capturing area to recognize one or more objects included in the image information based on the training result, identifies a specific 3D digital twin model related to the recognized object among a plurality of pre-stored 3D digital twin models, searches for a specific PLC data tag related to the identified specific 3D digital twin model among a plurality of pre-stored PLC data tags, connects the searched specific PLC data tag to the confirmed specific 3D digital twin model, generates the digital twin by performing 3D rendering based on the image information and the specific 3D digital twin model to which the specific PLC data tag is connected, and configures the generated digital twin as the SCADA scene using a preset 3D engine.

3. A method of recording or playing a supervisory control and data acquisition (SCADA) scene to which a digital twin of a SCADA system is applied, the method comprising:
outputting, by a server, a three-dimensional (3D) digital twin model connected to one or more programmable logic controller (PLC) data tags collected from a PLC corresponding to a facility to the SCADA scene, and storing the one or more PLC data tags collected from the PLC using a predetermined method at a preset cycle and additional information collected in relation to the facility in a buffer allocated to a database;
when a preset save button displayed on one side of the SCADA scene is selected, confirming, by the server, a preset storage method;
when the confirmed storage method is an integrated data storage method, allocating, by the server, a portion of the storage space of the database by linking with the database to configure an additional buffer;
based on a time of selecting the save button, storing, by the server, in the additional buffer, the one or more PLC data tags collected from one or more PLCs at the preset cycle and the additional information collected in relation to the facility from the time of selecting the save button to a time of selecting an end button later or during a preset additional save time;
when the end button is selected or the additional save time has elapsed, based on the time of selecting the save button, storing, by the server, in a timelist table and a page name universally unique identifier table (UUID) table allocated to the database, page information that includes the one or more PLC data tags and the additional information collected and stored in the buffer at the preset cycle from a time before the selection of the save button to the time of selecting the save button, the one or more PLC data tags and the additional information being stored in the additional buffer, information on a capturing area related to the equipment, one or more objects recognized from image information related to the facility, and information on the 3D digital twin model related to the SCADA scene; and
after the data stored in the buffer and the additional buffer is completely stored in the timelist table and the page name UUID table, initializing, by the server, the allocated buffer and the additional buffer by linking with the database.

4. The method of claim 3, further comprising:
when the confirmed storage method is a previous data storage method, storing, by the server, in the timelist table and the page name UUID table allocated to the database, the page information that includes the one or more PLC data tags and the additional information collected and stored in the buffer at the preset cycle from the time before the selection of the save button to the time of selecting the save button, information on a capturing area related to the equipment, one or more objects recognized from image information related to the facility, and information on the 3D digital twin model related to the SCADA scene; and
after the data stored in the buffer is stored in the timelist table and the page name UUID table, initializing, by the server, the allocated buffer by linking with the database.

5. The method of claim 3, further comprising:
when the confirmed storage method is a subsequent data storage method, allocating, by the server, a portion of the storage space of the database by linking with the database to configure an additional buffer;
based on the time of selecting the save button, storing, by the server, in another additional buffer, the one or more PLC data tags collected from one or more PLCs at the preset cycle and the additional information collected in relation to the facility from the time of selecting the save button to the time of selecting the end button later or during a preset additional save time;
when the end button is selected or when the additional storage time has elapsed, storing, by the server, in the timelist table and the page name UUID table allocated to the database, the page information that includes the one or more PLC data tags and the additional information being stored in the another additional buffer, the information on the capturing area related to the facility, the one or more objects recognized from the image information related to the facility, and the information on the 3D digital twin model related to the SCADA scene; and
after the data stored in the additional buffer is completely stored in the timelist table and the page name UUID table, initializing, by the server, the allocated buffer and the another additional buffer by linking with the database.

6. A method of recording or playing a supervisory control and data acquisition (SCADA) scene to which a digital twin of a SCADA system is applied, the method comprising:
when a preset playback menu displayed on one side of an app execution result scene on a preset SCADA software displayed on a server is selected, displaying, by the server, a file selection scene corresponding to the selected playback menu;
when information on any one of the SCADA scenes corresponding to the UUIDs related to one or more pieces of data included in a list displayed on the file selection scene of the server is selected, loading, by the server, the page information that includes the one or more PLC data tags, the additional information, the information on the capturing area related to the facility, the one or more objects recognized from the image information related to the facility, and the information on the 3D digital twin model related to the SCADA scene, which are being stored in the database in chronological order in response to the information on the selected one of the SCADA scenes, by linking with the database;
confirming, by the server, a specific 3D digital twin model related to the one or more objects loaded among a plurality of pre-stored 3D digital twin models;
connecting, by the server, the loaded one or more PLC data tags to the confirmed specific 3D specific twin model;
generating, by the server, the digital twin by performing the 3D rendering based on the specific 3D digital twin model connected to the one or more PLC data tags and the additional information; and
outputting, by the server, the generated digital twin to the SCADA scene.

7. The method of claim 6, further comprising:
when a check box of at least one option selection information is selected from among the pieces of option selection information related to the additional information displayed in a form of a check box on one side of the SCADA scene, updating, by the server, information related to the at least one option selection information corresponding to the selected check box to the digital twin and outputting the updated digital twin to the SCADA scene.
